(19) United States
(12) Patent Application Publication
(10) Pub. No.: US 2026/0115749 A1
(43) Pub. Date: Apr. 30, 2026

(54) PUMP DISPENSER HAVING A SAFETY LOCK CAP

(71) Applicant: Aspargo Laboratories, Inc., New York, NY (US)

(72) Inventors: Ravi Sawhney, Malibu, CA (US); Lance Hussey, Simi Valley, CA (US); Michael Kulick, Simi Valley, CA (US); Brian Weingarth, Woodland Hills, CA (US); Josh Probst, Culver City, CA (US); Cary Chow, Santa Monica, CA (US)

(73) Assignee: Aspargo Laboratories, Inc., New York, NY (US)

(21) Appl. No.: 19/338,904

(22) Filed: Sep. 24, 2025

Related U.S. Application Data
(60) Provisional application No. 63/698,272, filed on Sep. 24, 2024.

(51) Int. Cl. B05B 11/10

(52) U.S. Cl. CPC B05B 11/1059; B05B 11/1001

(57) ABSTRACT

Disclosed is a pump dispenser having a safety lock cap. Specifically, the device includes a container and an attached safety lock cap. A pump mechanism is attached with and between the container and safety lock cap. The safety lock cap has a locked, first configuration and an unlocked, second configuration. When in the first configuration the safety lock cap is locked and the pump mechanism is prohibited from dispensing.

Alternatively, when in the second configuration, the safety lock cap is unlocked and the pump mechanism is operable for dispensing the fluid.

### CROSS-REFERENCE TO RELATED APPLICATION

This is a non-provisional application of U.S. Ser. No. 63/698,272, filed on Sep. 24, 2024, the entirety of which is incorporated herein by reference.

### BACKGROUND OF THE INVENTION

### (1) Field of Invention

The present invention relates to medication containers and, more particularly, to a pump dispenser having a safety lock cap.

### (2) Description of Related Art

Medication containers are typically used to contain some form of medicine, whether it be in tablet or fluid form. A safety issue arises due to the need to prevent children or other parties from accessing the medicine therein.

Thus, a continuing need exists for a new and improved safety lock for a medication container and/or dispenser.

### SUMMARY OF INVENTION

The present disclosure provides a pump dispenser having a safety lock cap.

Specifically, the device includes a container and an attached safety lock cap. A pump mechanism is attached with and between the container and safety lock cap. The safety lock cap has a locked, first configuration and an unlocked, second configuration. When in the first configuration the safety lock cap is locked and the pump mechanism is prohibited from dispensing and, when in the second configuration, the safety lock cap is unlocked and the pump mechanism is operable for dispensing the fluid.

In one aspect, when in the second configuration, depressing at least a portion of the safety lock cap actuates the pump mechanism to draw fluid from the container and out of a dispensing hole formed in the safety lock cap.

Further and in one aspect, the safety lock cap includes a pair of press tabs. The press tabs are formed to selectively unlock the safety lock cap, such that upon depression of the press tabs, the safety lock cap is rotatable from the first configuration into the second configuration, where it can be depressed to actuate the pump mechanism.

In another aspect, the safety lock cap includes a slider tab connected to a locking mechanism that selectively engages with a ledge formed on the container. The slider tab is slidable such that sliding the slider tab withdraws the locking mechanism from the first configuration (in which the locking mechanism engages with the ledge) to a second configuration (in which the locking mechanism is withdrawn from the ledge). When the locking mechanism is withdrawn from the ledge, the safety lock cap is in an unlocked configuration. In such a configuration, depressing at least a portion of the safety lock cap actuates the pump mechanism to draw fluid from the container and out of a dispensing hole formed in the safety lock cap.

Additionally, the safety lock cap further comprises a bias mechanism to bias the slider tab in the locked, first configuration. The bias mechanism is, for example, a plastic living spring.

In yet another aspect, the safety lock cap includes a central depressible button surrounded by a cover. The cover includes depressible portions that, when depressed, unlock the cover from the first configuration to allow a user to selectively rotate the cover and lower the cover to expose the depressible button and a dispensing hole in the second configuration. When in the second configuration and the depressible button is fully exposed, the depressible button is depressible to actuate the pump mechanism and force fluid from the container and out of the dispensing hole.

Finally and as can be appreciated by those skilled in the art, the present disclosure also includes a method for forming and using the invention as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is an isometric-view illustration of a pump dispenser having a safety lock cap in accordance with various embodiments of the present invention;

FIG. 1B is a front-view illustration of the pump dispenser having a safety lock cap in accordance with various embodiments of the present invention;

FIG. 1C is a side-view illustration of the pump dispenser having a safety lock cap in accordance with various embodiments of the present invention;

FIG. 2 is an isometric-view illustration of the pump dispenser, depicting operation of the safety lock cap;

FIG. 3A is a side, cross-sectional view illustration of the pump dispenser having a safety lock cap in accordance with various embodiments of the present invention;

FIG. 3B is a front, cross-sectional view illustration of the pump dispenser having a safety lock cap in accordance with various embodiments of the present invention;

FIG. 4A is an isometric-view illustration of a pump dispenser having a safety lock cap in accordance with various embodiments of the present invention;

FIG. 4B is a front-view illustration of the pump dispenser and safety lock as shown in FIG. 4A;

FIG. 4C is a side-view illustration of the pump dispenser and safety lock as shown in FIG. 4A;

FIG. 5 is an isometric-view illustration of the pump dispensers shown in FIG. 4A, depicting operation of the safety lock cap;

FIG. 6A is a side, cross-sectional view illustration of the pump dispenser shown in FIG. 4A;

FIG. 6B is a front, cross-sectional view illustration of the pump dispenser shown in FIG. 4A;

FIG. 7 is a cross-sectional view illustration of the pump dispenser shown in FIG. 4A, depicting operation of the safety lock cap;

FIG. 8A is an isometric-view illustration of a pump dispenser having a safety lock cap;

FIG. 8B is an isometric-view illustration of the pump dispenser shown in FIG. 8A, depicting operation of the safety lock cap;

FIG. 8C is an isometric-view illustration of the pump dispenser shown in FIG. 8A, depicting operation of the safety lock cap;

FIG. 9A is an isometric-view illustration of a pump dispenser having a safety lock cap;

FIG. 9B is an isometric-view illustration of the pump dispenser shown in FIG. 9A, depicting operation of the safety lock cap;

FIG. 9C is an isometric-view illustration of the pump dispenser shown in FIG. 9A, depicting operation of the safety lock cap; and

FIG. 10 is a cross-sectional, side-view illustration of a lotion pump assembly of the prior art.

### DETAILED DESCRIPTION

The present invention relates to medication containers and, more particularly, to a pump dispenser having a safety lock cap. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means”or “step”clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction.

Instead, they are used to reflect relative locations and/or directions between various portions of an object.

### (1) Description

The present invention relates to a safety lock cap that can be incorporated into a medication container. Specifically and in various embodiments, the invention is a pump dispenser that can be used to dispense a variety of fluids. In some aspects, the fluid is medicine. In various embodiments, the pump dispenser includes a traditional pump mechanism that can be used to pump the fluid or liquid medicine as a spray that can be sprayed into a user's mouth (or on their skin, etc.). Any traditional pump/spray mechanism can be used; however, the innovation here is the safety lock cap that is incorporated into the pump dispenser. The safety lock cap prevents inadvertent dispensing as well as requiring a certain level of skill to prevent children from using and pumping the medicine or fluid from the dispenser.

As shown in the drawings, there are several various aspects of the safety lock cap that can be incorporated into the pump dispenser to allow it to be selectively moved from a locked, first configuration into an unlocked, second configuration. For example, in one aspect, the cap can be rotated to align with the dispensing hole. In some aspects, the cap could be pushed down and rotated, or pulled up and rotated, or squeezed and rotated. Other aspects include a slide that unlocks the cap to allow the cap to be manipulated to orient or expose the dispensing hole. Several specific examples of the safety lock cap and its operation between the first and second configurations are provided below.

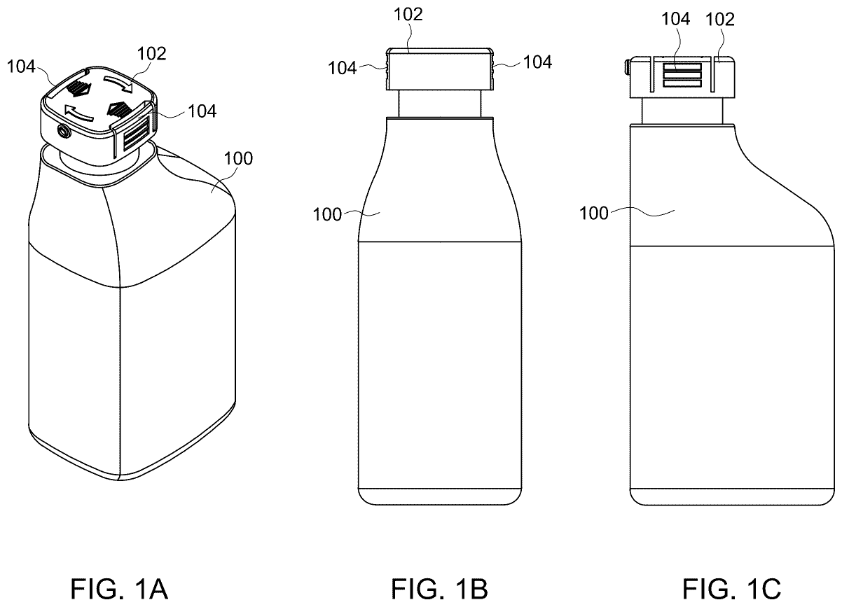

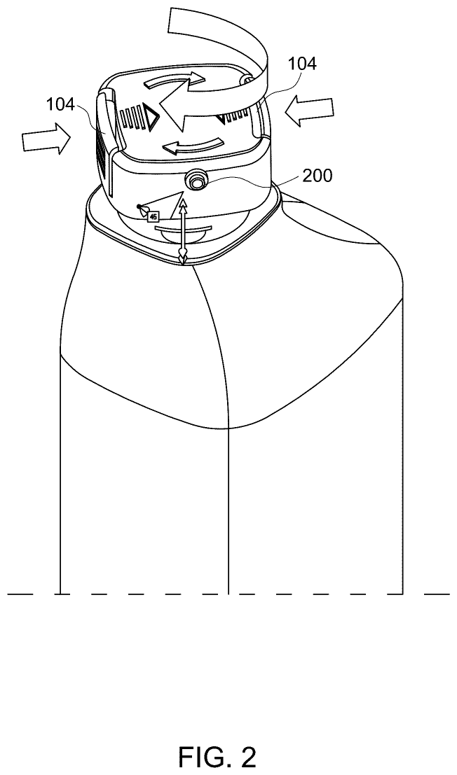

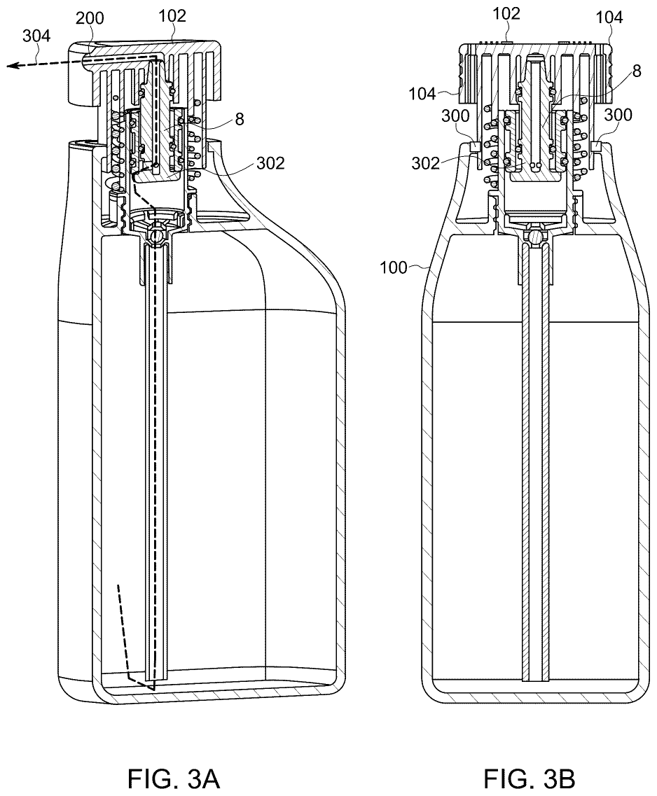

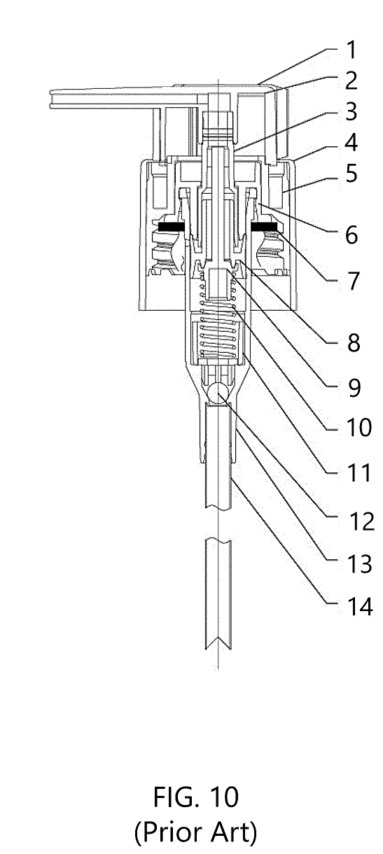

In one aspect and as shown in FIGS. 1A through 3C, the present disclosure provides a container 100 having the pump dispenser with a safety lock cap 102. The safety lock cap 102 in this aspect includes press tabs 104 on both sides of the cap 102 that need to be squeezed to allow the cap 102 to rotate and for the pump mechanism to align in an activation position in which a user can press down on the cap to dispense the medication or fluid therein. As shown in FIG. 2, depressing or squeezing the tabs 104 allows a user to unlock the cap and rotate (e.g., rotate 90 degrees) the cap 102 and dispensing hole 200 from a locked, first configuration into a dispensing position (second configuration). Notably, the cap 102 includes any suitable mechanism or device that allows it to selectively unlock through pressing and rotating the cap 102. As a non-limiting example and as shown in FIG. 3B, the tabs 104 are connected with protrusions 300 that engage with detents in the neck of the container 100. In this example, pressing the tabs 104 withdraws the tabs from the detents which allow the cap 102 to rotate to a dispensing position, where it can be depressed to dispense the solution. For example, when in the dispensing position, there are vertical guides to accommodate the protrusions 300 to allow the cap 102 to be depressed and actuate the pump mechanism 302. The pump mechanism 302 is any suitable mechanism or assembly that can be affixed with a container to allow for pumping or otherwise dispensing a medication or fluid therefrom, a non-limiting example of which includes a compression or spring-loaded pump, similar to the pump mechanism as used in a standard lotion bottle. For reference, FIG. 10 provides an illustration of an example pump mechanism as provided for in the prior art, which can be incorporated into the invention of the present disclosure as the pump mechanism 302. The pump mechanism of the prior art (as shown in FIG. 10) includes a clamp 1, press head 2, press lever 3, coat 4, screw cap 5, connect cap 6, gasket 7, piston 8, piston seat 9, spring 10, spring seat 11, valve 12, housing 13, and a straw 14. As applied to the present application, such a pump mechanism can be connected with the safety lock cap 102 such that depressing the cap 102 activates the pump mechanism 302 to pump medicine from the container 100 and out of the dispensing hole 200 via the pathway 304 shown in FIG. 3A. In other words and as illustrated in FIGS. 3A and 3B, the cap 102 operates as the press head (of FIG. 10) and is slidably connected with the container 100 such that when unlocked, the pressing the cap 102 downward forces the attached piston 8 downward to operate the pump mechanism 302 and dispense the medicine.

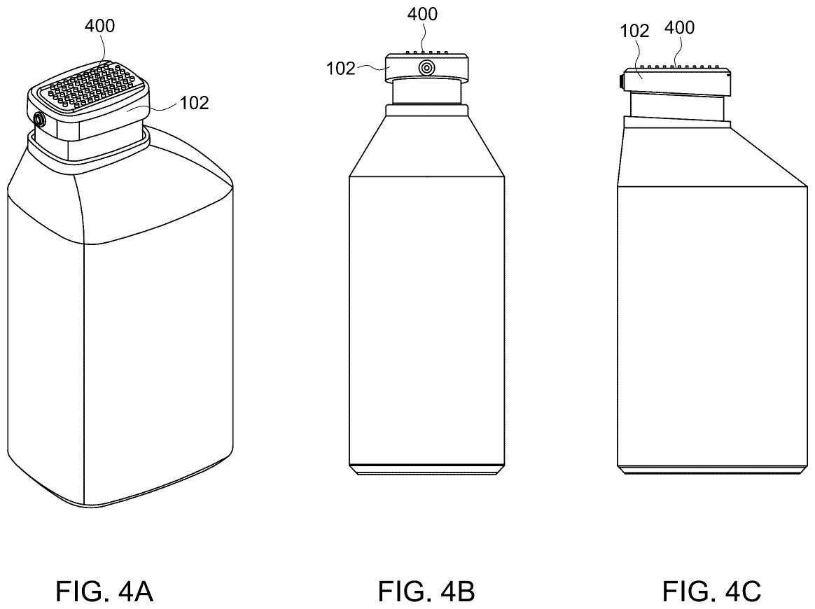

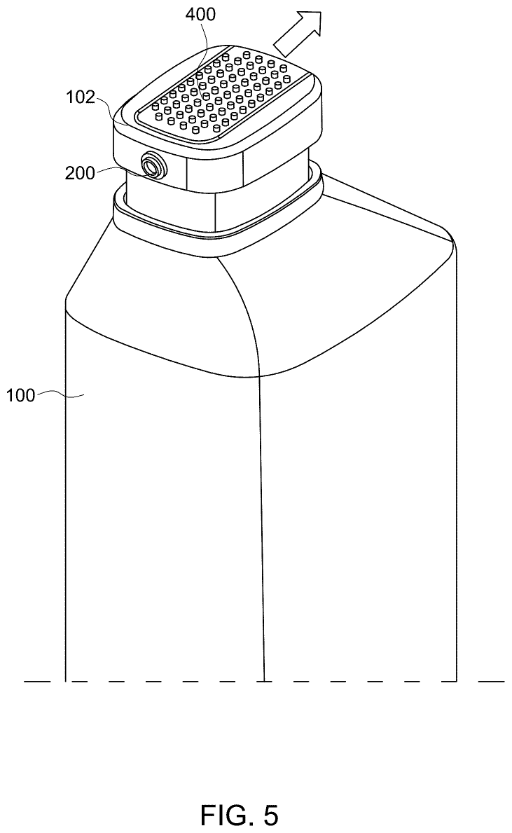

As noted above, the present disclosure provides additional aspects by which the safety lock cap 102 can be implemented. For example, FIGS. 4A through 7 depict another aspect in which the cap 102 includes a slider mechanism 400 that must be slid back to press the cap 102 down to actuate the pump mechanism and dispense the medicine or fluid. As shown in FIG. 5, the cap 102 includes a slider mechanism 400 that is used to release an internal locking feature on the cap 102 to unlock the cap 102 so that it can be depressed to pump the pump mechanism. As was the case above, pumping the pump mechanism forces fluid from the container 100, through the pump mechanism, and out of the dispensing hole 200 in the cap 102.

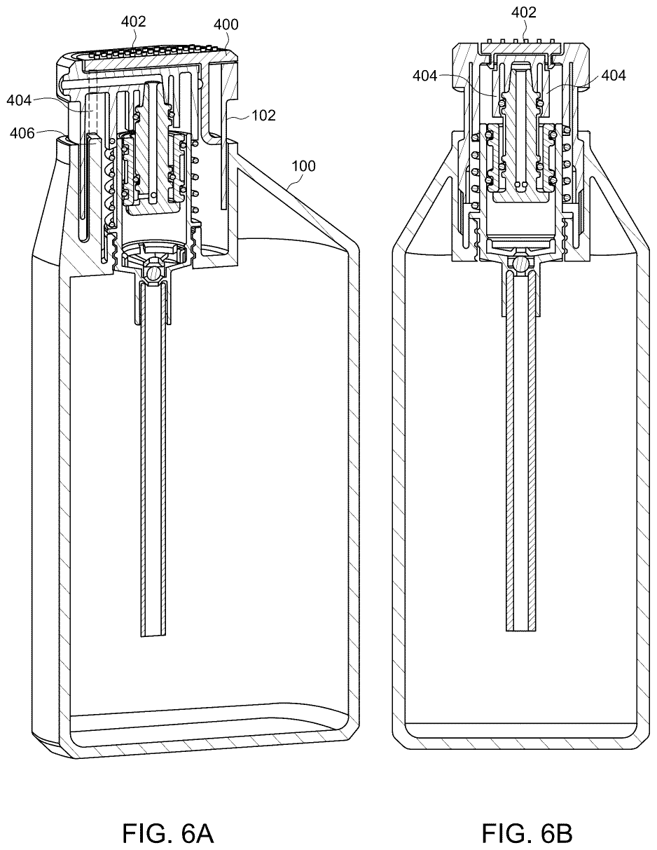

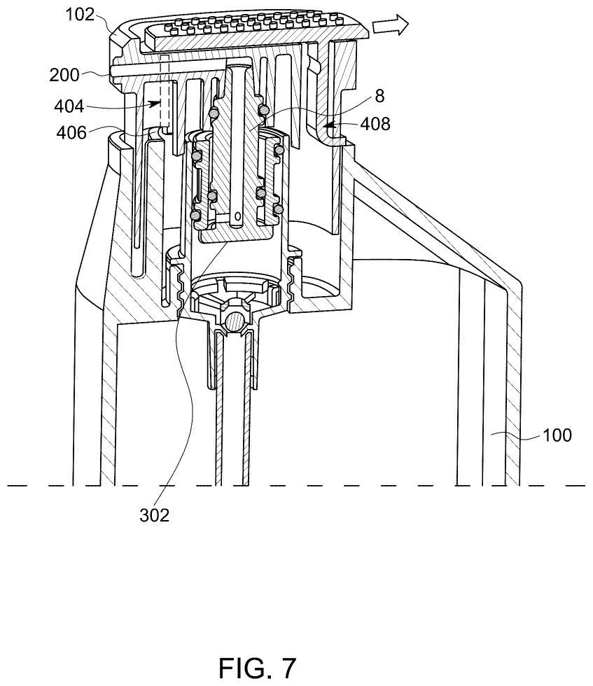

For further understanding, FIGS. 6A, 6B, and 7 provide cross-sectional view illustrations of the cap 102 and associated slider mechanism 400. Specifically, FIGS. 6A and 6B depict the slider mechanism 400 in a locked configuration. As shown, the slider mechanism 400 includes a slider tab 402 that is connected with an internal locking mechanism (e.g., ridge 404) that rests on a ledge 406 on the lower container 100. In this aspect, the ridge 402 protrudes downward from the slider tab 402 and is used to selectively lock/unlock the cap 102. For example, the ridge 404 locks the cap 102 against the ledge 406 so that it cannot be dispensed/pumped until the slider tab 402 is pulled back and the ridge 404 is withdrawn from the ledge 406.

FIG. 7 depicts the cap 102 in an unlocked configuration. In this aspect and as shown, the slider tab 402 is slid back to withdraw the ridge 404 from the ledge 406, thus releasing the internal locking feature to unlock the bottle. When unlocked, the cap 102 can be depressed to force the piston 8 downward and pump the pump mechanism 302, thereby forcing fluid from container 100 and out from the dispensing hole 200. In some aspects, the slider tab 402 is desirably biased into the locking position, meaning that the user must selectively hold the tab 402 into the unlocked position while depressing the cap 102. Thus, in this aspect, the cap 102 includes any suitable bias mechanism to bias the slider tab 402 in the locked position. As a non-limiting example, the cap 102 includes a spring type configuration, such as a plastic living spring 408 that returns to slider tab 402 back to the locked position when released by the user.

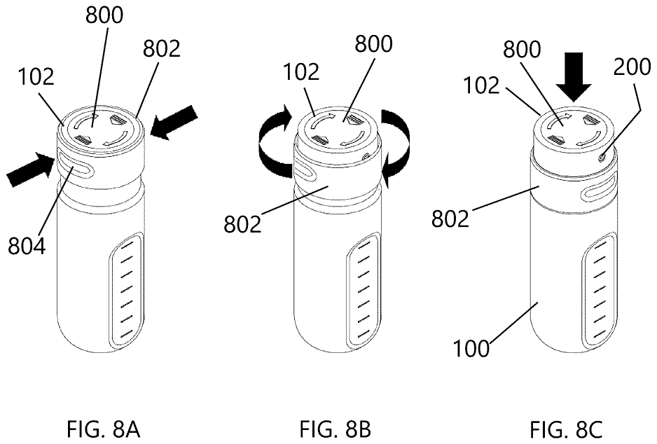

FIGS. 8A through 8C depict another aspect of the safety lock cap 102. In this aspect, the cap 102 has a central depressible button 800 surrounded by a sleeve or cover 802. The cover 802 includes depressible portions 804 that can be depressed to unlock the cover 802 and allow a user to selectively rotate the cover 802 via a threaded detail to lower the cover 802. The depressible portions 804 include any suitable mechanism or technique that can be employed to select unlock the cover 802 upon depression, a non-limiting example of which includes a locking tab and associated catch or detent. Thus, in one example, depressing the depressible portions 804 withdraws a tab from a catch to allow a user to selectively rotate and lower the cover 802.

By lowering the cover 802, the depressible button 800 is fully revealed, along with the dispensing hole 200 (as shown in FIG. 8C). With the depressible button 800 fully revealed, a user can depress the button 800 and, in turn, pump the pump mechanism (described above as element 302) to force fluid from the container 100 and out of the dispensing hole 200. A spring or other bias means can be employed to cause the cover 802 to slide (rotate) back up to a locked configuration after actuation of the depressible button 800 and associated pump mechanism.

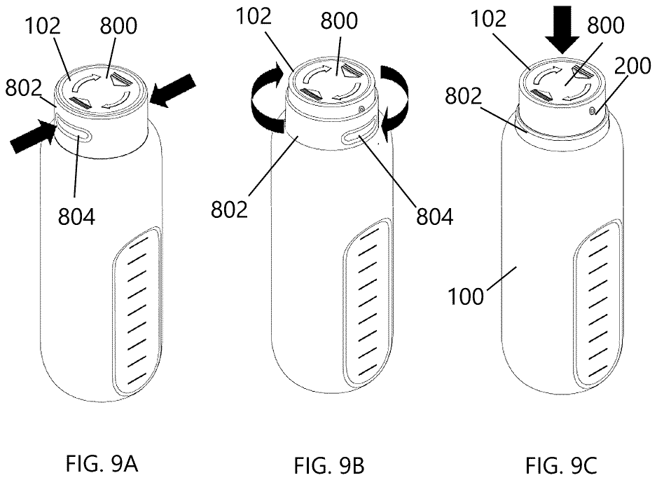

Another aspect is illustrated in FIGS. 9A through 9C. The mechanism and operation of the cover 102 as shown in FIGS. 9A through 9C is similar to that of the aspect as depicted and described above with respect to FIGS. 8A through 8C; however, in this aspect, upon depressing the depressible portions 804, the cover 802 is unlocked and allowed to rotate downward (shown in FIG. 8B) and into a sleeve formed within the container 100 to conceal the cover 802 and expose the depressible button 800 and dispensing hole 200 (shown in FIG. 8C). As was the case above, with the depressible button 800 fully revealed, a user can depress the button 800 and, in turn, pump the pump mechanism (described above as element 302) to force fluid from the container 100 and out of the dispensing hole 200. A spring or other bias means can be employed to cause the cover 802 to slide (rotate) back up to a locked configuration after actuation of the depressible button 800 and associated pump mechanism.

Thus and as can be appreciated by those skilled in the art given this description and the drawings as submitted herewith, there are several variations that can be implemented for the pump dispenser and associated safety lock cap in accordance with various embodiments of the present invention.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A pump dispenser having a safety lock cap, comprising:
a container formed to hold a fluid therein;
a safety lock cap attached with the container;
a pump mechanism attached with and between the container and safety lock cap; and
wherein the safety lock cap has a locked, first configuration and an unlocked, second configuration, where when in the first configuration the safety lock cap is locked and the pump mechanism is prohibited from dispensing and, when in the second configuration, the safety lock cap is unlocked and the pump mechanism is operable for dispensing the fluid.

2. The pump dispenser having a safety lock cap as set forth in claim 1, wherein when in the second configuration, depressing at least a portion of the safety lock cap actuates the pump mechanism to draw fluid from the container and out of a dispensing hole formed in the safety lock cap.

3. The pump dispenser having a safety lock cap as set forth in claim 2, wherein the safety lock cap includes a pair of press tabs, the press tabs being formed to selectively unlock the safety lock cap, such that upon depression of the press tabs, the safety lock cap is rotatable from the first configuration into the second configuration, where it can be depressed to actuate the pump mechanism.

4. The pump dispenser having a safety lock cap as set forth in claim 2, wherein the safety lock cap includes a slider tab connected to a locking mechanism that selectively engages with a ledge formed on the container, the slider tab being slidable such that sliding the slider tab withdraws the locking mechanism from the first configuration in which the locking mechanism engages with the ledge to a second configuration in which the locking mechanism is withdrawn from the ledge.

5. The pump dispenser having a safety lock cap as set forth in claim 4, wherein when the locking mechanism is withdrawn from the ledge, the safety lock cap is in an unlocked configuration in which depressing at least a portion of the safety lock cap actuates the pump mechanism to draw fluid from the container and out of a dispensing hole formed in the safety lock cap.

6. The pump dispenser having a safety lock cap as set forth in claim 5, wherein the safety lock cap further comprises a bias mechanism to bias the slider tab in the locked, first configuration.

7. The pump dispenser having a safety lock cap as set forth in claim 6, wherein the bias mechanism is a plastic living spring.

8. The pump dispenser having a safety lock cap as set forth in claim 2, wherein the safety lock cap includes a central depressible button surrounded by a cover.

9. The pump dispenser having a safety lock cap as set forth in claim 8, wherein the cover includes depressible portions that, when depressed, unlock the cover from the first configuration to allow a user to selectively rotate the cover and lower the cover to expose the depressible button and a dispensing hole in the second configuration.

10. The pump dispenser having a safety lock cap as set forth in claim 9, wherein when in the second configuration and the depressible button is fully exposed, the depressible button is depressible to actuate the pump mechanism and force fluid from the container and out of the dispensing hole.
